(19) United States
(12) Patent Application Publication
(10) Pub. No.: US 2008/0304683 A1
(43) Pub. Date: Dec. 11, 2008

(54) Stereo Sound Image Forward Headphone

(76) Inventor: Hsin-Yuan Kuo, Kaohsiung County (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 12/129,946

(22) Filed: May 30, 2008

(30) Foreign Application Priority Data
Jun. 5, 2007 (TW) 96209241

(51) Int. Cl. H04R 5/02

(52) U.S. Cl. 381/309

(57) ABSTRACT

A stereo sound image forward headphone is provided. The stereo sound image forward headphone utilizes a speaker provided on the ear hanger, which is spaced apart from a user's ear by a distance, such that sound from the speaker is on the front side of the user's ear. The stereo sound image forward headphone not only creates a natural impression of sound heard from various directions as in natural hearing, but also protects the user's ear from hearing loss which might otherwise result from long use of a headphone.

### FIELD OF THE INVENTION

The present invention relates to stereo sound image forward headphones, and more particularly, to a stereo sound image forward headphone utilizing a speaker provided on an ear hanger such that sound from the speaker is on the front side of the user's ear.

### DESCRIPTION OF RELATED ART

Headphones are often used in daily life of people nowadays. Speakers of conventional headphones always abut against the user's ears. Referring to FIG. 1 and FIG. 2, which are top plan views of an earphone 1 and a circumaural headphone 2 respectively. Referring to FIG. 1 and FIG. 2 simultaneously, a speaker 3 of the earphone 1 or the circumaural headphone 2 abuts against the user's ear 4 while playing music and attempts to allow the music to reach the inside of the ear directly. In so doing, noise can be muffled. The drawbacks, however, are as follows: while music in a natural environment has to end up mostly in the user's ear 4, nonetheless sound images generated by a conventional headphone unfold in the ear canal between both ears, thus creating a false impression of the otherwise stereo music being heard from only one direction; and the user's ear 4 is likely to suffer hearing loss because of long use of a conventional headphone that abuts against the user's ear.

The Human ear is capable of discerning the source of sound. The left ear and the right ear discern the direction of sound from the same source as long as the sound reaches the left ear and the right ear at different time. As mentioned earlier, the left ear and the right ear perceive sound from a conventional headphone respectively, and thus sound images unfold in the ear canal between both ears of the user wearing the headphone. The brain's discernment of sound depends on experience. A headphone plays music by reproducing genuine music previously recorded, whether the genuine music is pop music, classical music, or even music performed live at a concert. While the source of the genuine music played by the headphone should be located in front of the user's ears, nonetheless sound images generated by a conventional headphone unfold in the ear canal between both ears. As revealed by the theory of acoustic psychology, the human brain continuously tries to discern the source of sound, but all such attempts are in vain in the aforesaid headphone usage condition. As a result, the conventional headphones eventually stretch the users' auditory function at a subconscious level. Therefore, long use of the conventional headphones is tiring.

Accordingly, a problem that calls for immediate solution and to be solved by the present invention involves providing a stereo headphon. The stereo sound image forward headphone utilizes a speaker provided on ear hanger, which is spaced apart from a user's ear by a distance, such that sound from the speaker is on the front side of the user's ear. The stereo sound image forward headphone not only creates a natural impression of sound heard from various directions as in natural hearing, but also protects the user's ear from hearing loss which might otherwise result from long use of a headphone.

### SUMMARY OF THE INVENTION

In view of the aforesaid drawbacks of the prior art, the inventor of the present invention realized the room for improvement of the prior art. Hence, the inventor endeavored to devise a stereo sound image forward headphone based on the inventor's expertise and years of practical experience. The stereo sound image forward headphone utilizes a speaker provided on an ear hanger. Sound from the speaker is on the front side of the user's ear. The stereo sound image forward headphone creates a natural impression of sound heard from various directions as in natural hearing.

The primary objective of the present invention is to provide stereo sound image forward headphones, and more particularly, to a stereo sound image forward headphone utilizing a speaker provided on an ear hanger, which is spaced apart from a user's ear by a distance such that sound from the speaker is on the front side of the user's ear, thereby allowing the stereo sound image forward headphone to create a natural impression of sound heard from various directions as in natural hearing and protect the user's ear from hearing loss which might otherwise result from long use of a headphone.

The present invention provides a stereo sound image forward headphone. The stereo sound image forward headphone comprises at least one ear hanger capable of being hung on a user's ear, and at least one speaker provided on the ear hanger, which is spaced apart from a user's ear by a distance, such that sound from the speaker is on the front side of the user's ear.

Accordingly, utilizing the speaker provided on the ear hanger, which is spaced apart from a user's ear by a distance, such that sound from the speaker is on the front side of the user's ear allows the stereo sound image forward headphone to create a natural impression of sound heard from various directions as in natural hearing.

### BRIEF DESCRIPTION OF DRAWINGS

FIG. 1 is a top plan view showing an ear hanger of a conventional earphone;

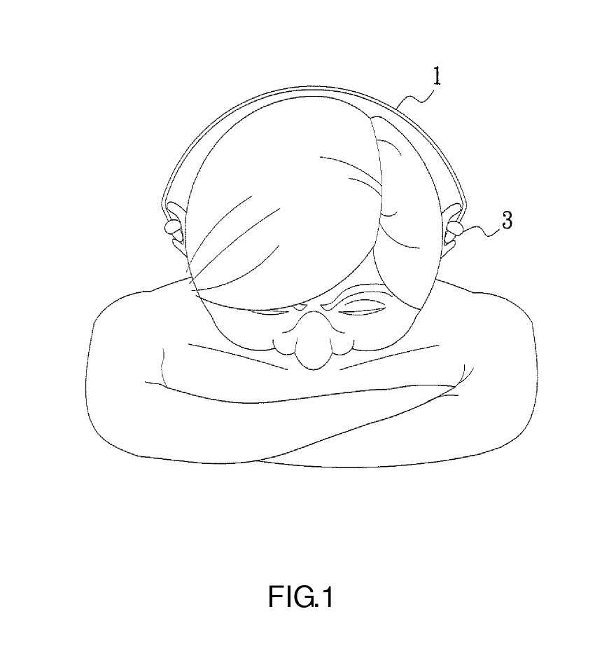

FIG. 2 is a top plan view showing an ear hanger of a conventional circumaural headphone;

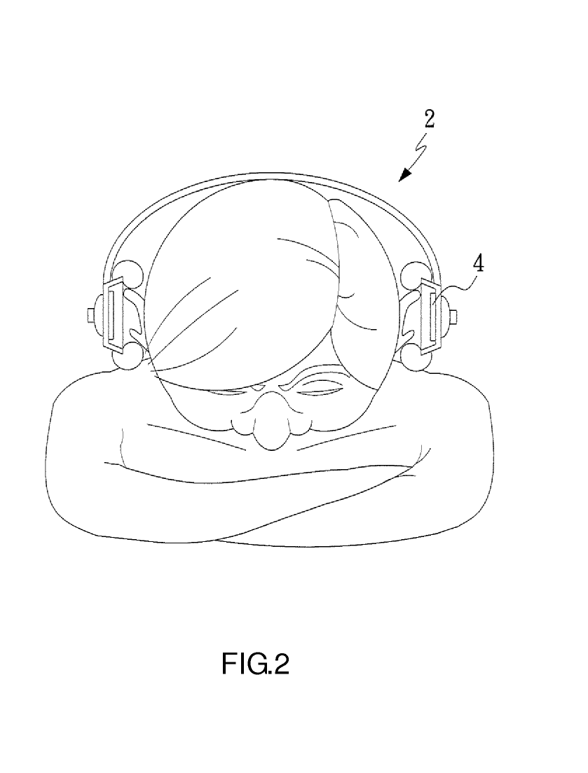

FIG. 3 is a cross-sectional view showing a stereo sound image forward headphone of a first preferred embodiment of the present invention;

FIG. 4 is a cross-sectional view showing a stereo sound image forward headphone of a second preferred embodiment of the present invention;

FIG. 5 is a cross-sectional view showing a stereo sound image forward headphone of a third preferred embodiment of the present invention; and

FIG. 6 is a cross-sectional view showing a stereo sound image forward headphone of a fourth preferred embodiment of the present invention.

### DETAILED DESCRIPTION OF PREFERRED EMBODIMENTS

The present invention is herein illustrated with specific embodiments and the accompanying drawings, so that one skilled in the pertinent art can easily understand objectives, features, other advantages and effects of the present invention from the following disclosure of the invention.

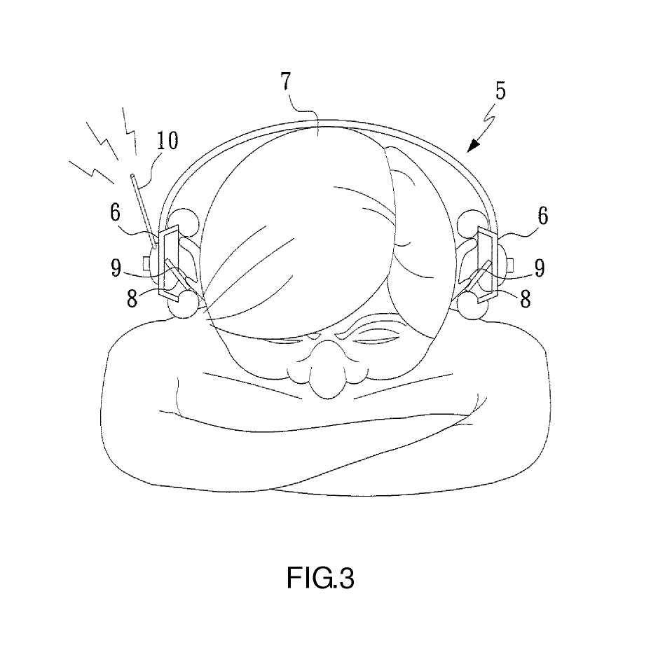

Referring to FIG. 3, which is a cross-sectional view showing a stereo sound image forward headphone of a first preferred embodiment of the present invention. Referring to FIG. 3, a stereo sound image forward headphone 5 comprises at least an ear hanger 6 (two ear hangers are provided bilaterally in the first preferred embodiment) capable of being hung on the ear 8 of a user 7, and at least a speaker 9 provided on the ear hanger 6, which is spaced apart from the ear 8 of the user 7 by a distance such that sound from the speaker 9 is on the front side of the ear 8 of the user 7. The stereo sound image forward headphone 5 further comprises a signal input device 10 for inputting a sound signal to the stereo sound image forward headphone 5. In the first preferred embodiment, the signal input device 10 is a wireless signal input device or a wired signal input device. The stereo sound image forward headphone 5 further comprises a power device (not shown), such as a battery and a sound control device (not shown), for supplying the stereo sound image forward headphone 5 with required power and adjusting timbre or volume of the stereo sound image forward headphone 5 respectively.

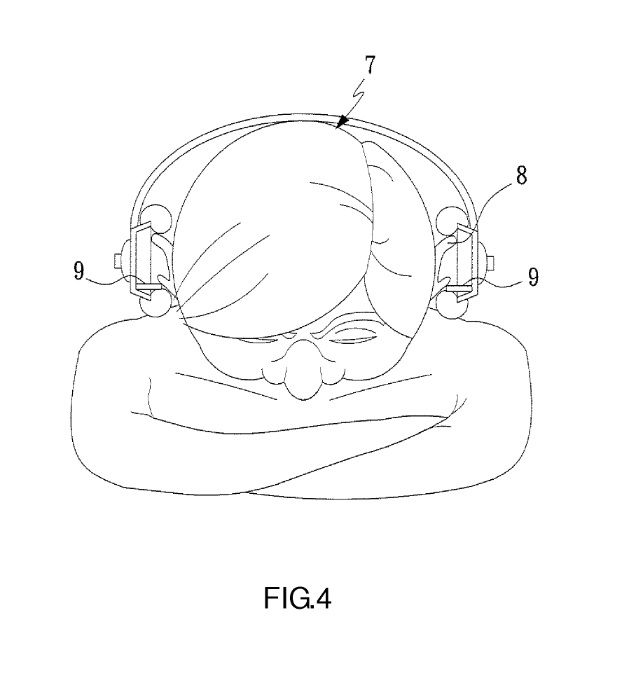

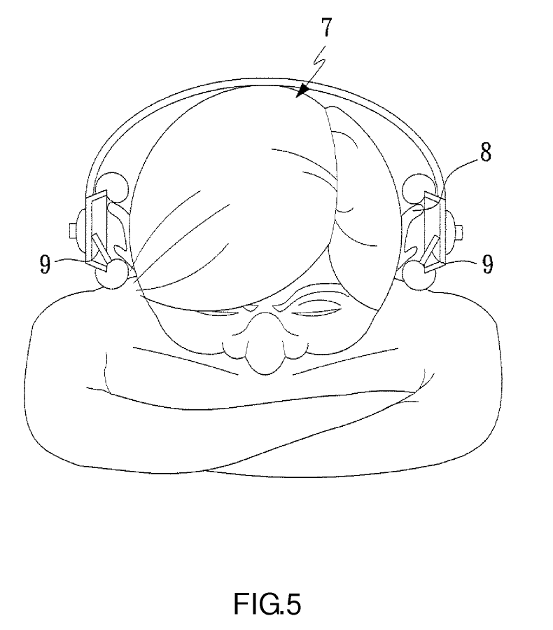

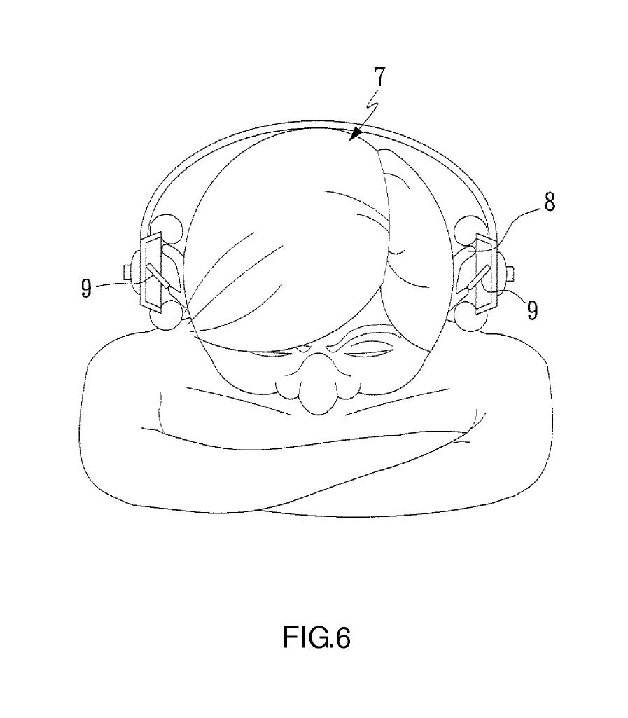

Referring to FIGS. 4 to 6, which is a cross-sectional view showing a stereo sound image forward headphone of second to fourth preferred embodiments of the present invention Referring to FIGS. 4 to 6, the second to fourth preferred embodiments of the present invention differ from the first preferred embodiment of the present invention due to the arrangement of speaker 9. However, the speaker 9 is also spaced apart from the ear 8 of the user 7 by a distance, such that sound from the speaker 9 is on the front side of the ear 8 of the user 7.

As described above, the present invention provides a stereo sound image forward headphone. The stereo sound image forward headphone utilizes a speaker provided on an ear hanger, which is spaced apart from a user's ear by a distance, such that sound from the speaker is on the front side of the user's ear. The stereo sound image forward headphone not only creates a natural impression of sound heard from various directions as in natural hearing, but also protects the user's ear from hearing loss which might otherwise result from long use of a headphone. As regards industrial application, products derived from the present invention will certainly meet the need of the current market to the full.

The foregoing specific embodiments are fully disclosed. However, it is apparent to those skilled in the art that the embodiments are only illustrative of the features and functions of the present invention but are not intended to restrict the scope of the present invention. It should be noted that all equivalent modifications and variations made in the foregoing embodiment should fall within the scope of the disclosure. Thus, the protection of the invention depends on the appended claims.

What is claimed is:

1. A stereo sound image forward headphone, comprising:
at least one ear hanger capable of being hung on the ear of a user;
at least one speaker provided on the ear hanger, which is spaced apart from the ear of the user by a distance such that sound from the speaker is on the front side of the user's ear.

2. The stereo sound image forward headphone of claim 1, further comprising a signal input device for inputting a sound signal to the stereo sound image forward headphone.

3. The stereo sound image forward headphone of claim 2, wherein the signal input device is a wired signal input device.

4. The stereo sound image forward headphone of claim 2, wherein the signal input device is a wireless signal input device.

5. The stereo sound image forward headphone of claim 1, further comprising a power device for supplying the stereo sound image forward headphone with required power.

6. The stereo sound image forward headphone of claim 5, wherein the power device is a battery.

7. The stereo sound image forward headphone of claim 1, further comprising a sound control device for adjusting timbre or volume of the stereo sound image forward headphone.
